(19) United States
(12) Patent Application Publication
(10) Pub. No.: US 2005/0047415 A1
(43) Pub. Date: Mar. 3, 2005

(54) Data traffic manager and method therefor

(76) Inventors: Radhakrishna Channegowda, Bangalore (IN); Dhananjay S. Patki, Bangalore (IN)

Correspondence Address: FREESCALE SEMICONDUCTOR, INC.;LAW DEPARTMENT, 7700 WEST PARMER LANE MD:TX32/PL02, AUSTIN, TX, 78729, US

(21) Appl. No.: 10/649,924

(22) Filed: Aug. 28, 2003

(51) Int. Cl. H04L 12/56

(52) U.S. Cl. 370/395.4; 370/412

(57) ABSTRACT

A data traffic manager includes a time-spaced round robin (TSRR) scheduler and an enqueue engine. The enqueue engine is connected to an ATM data port and receives cells of data and determines whether the cell data is one of conformant and non-conformant. The data is placed into one of a plurality of per-class shaper queues that are spaced generally equally in time. A conformant cell is queued to a currently served queue and a non-conformant cell is shaped based on a cell delay time. The TSRR scheduler schedules cells of data from the shaper queues for transmission using a time-spaced round robin algorithm.

### BACKGROUND OF THE INVENTION

The present invention relates to a method and apparatus for data traffic management and, more particularly, to a time-spaced traffic management system for ATM data that uses per-class queues.

The growth and popularity of the Internet has led to tremendous amounts of data (voice, video, etc.) being transmitted from point to point and between servers. Multimedia and other high-bandwidth applications support Asynchronous Transfer Mode (ATM), which supports a wide variety of services and applications. An ATM network should be capable of providing differentiated Quality of Service (QoS) to these services and applications. Traffic Management protects the network and the end systems from congestion and promotes efficient use of network resources. Generic functions such as Connection Admission Control, Feedback Control, Usage Parameter Control, Cell Loss Priority Control, Traffic Shaping, Network Resource Management and Frame Discard are provided to facilitate efficient traffic management.

An ATM multiplexer connects different user devices (for example, DS1, DS3, T1/E1, Ethernet) then translates the protocols to ATM cell format and multiplexes the cells into a UNI interface (OC-3c or DS3 PLCP). The UNI interface may connect to the ATM switch. The combination of interfaces and services presents a difficult challenge to multiplexer implementation. The interface between the multiplexer and the network should support statistical multiplexing, traffic management, cell buffering, cell queuing, priority schemes, and fairness algorithms in accordance with data transmission standards. Traditional approaches require separate hardware and general purpose CPUs for each interface type and protocol, which results in many individual designs and limited reuse of software.

Conventional shaping and scheduling algorithms used for ATM traffic management involve per-VC (Virtual Connection) queues. Such per-VC queues are processed with multi-level scheduling (two or more, for example, one for ATM classes and one for VCs) and shaping mechanisms. Typical shaping and scheduling algorithms include GCRA (Generic Cell Rate Algorithm), Priority Scheduling, WFQ, Scoreboard Scheduling, Fair Share Scheduling, Timestamp Scheduling, etc. However, per-VC queue processing requires a lot of computational resources and as such, is typically done in hardware.

Per-VC queuing and multi-level scheduling involves as many queues as the number of VCs and all of the queues must be scanned for each cell transmission. The larger the number of VCs, the larger the number of scans, making the processing complex and requiring an increasing amount of computing resources. Hence, some implementations compromise on the number of VCs that can be supported. Other implementations use two-dimensional timing chains that need frequent chain manipulations adding to computational overheads. Timestamp based scheduling mechanisms need a plurality of timers running at various time granularities making timer management complex. Some prioritized queue shaping mechanisms treat different classes of traffic alike. Some fair share schedulers perform round robin scheduling across VCs, however, do not distinguish between different classes of traffic.

One proposed method replaces per-VC shaping queues that must be processed during each cell-emission period with a sequence of shaping queues shared by a plurality of virtual circuits only one of which must be processed during each cell-emission period. However, queuing cells of different VCs/classes to the shaper queues and scheduling of the shaper queues is quite complex. A cell arriving late causes designation of serving queues of all the VCs to be shifted, the impact of which is not clear. Also, for variable-bit-rate VCs, an additional overflow queue is required.

It would be desirable to provide a method and apparatus that performs efficient and cost-effective traffic management. It further would be desirable to have a traffic management process that does not cause defects.

### BRIEF DESCRIPTION OF THE DRAWINGS

The following detailed description of preferred embodiments of the invention, will be better understood when read in conjunction with the appended drawings. For the purpose of illustrating the invention, there is shown in the drawings embodiments that are presently preferred. It should be understood, however, that the invention is not limited to the precise arrangement and instrumentalities shown. In the drawings:

FIG. 1 is block diagram of a data traffic manager in accordance with an embodiment of the present invention;

FIG. 2 is a block diagram of another data traffic manager in accordance with an embodiment of the present invention; and

FIG. 3 is a flow chart illustrating a modified generic cell rate algorithm of a data traffic manager in accordance with an embodiment of the present invention.

### DETAILED DESCRIPTION OF PREFERRED EMBODIMENTS

The detailed description set forth below in connection with the appended drawings is intended as a description of the presently preferred embodiment of the invention, and is not intended to represent the only form in which the present invention may be practiced. It is to be understood that the same or equivalent functions may be accomplished by different embodiments that are intended to be encompassed within the spirit and scope of the invention. As will be understood by those of skill in the art, the present invention can be applied to various packages and package types. In the drawings, like numerals are used to indicate like elements throughout.

The present invention is a data traffic manager that uses a time spaced round robin (TSRR) scheduler. The TSRR scheduler uses just per-class queues and avoids the use of per-VC queues and their associated complex processing. The TSRR algorithm is computationally efficient as it uses a modified GCRA and simple round robin mechanisms for processing the class queues. The TSRR scheduler significantly reduces the resources required, both processing and memory, thereby reducing the overall cost of ATM Traffic Management.

In one embodiment, the present invention is a data traffic manager having an enqueue engine connected to at least one port for receiving cells of data and a plurality of per-class shaper queues connected to the enqueue engine that receive respective cells of data from the enqueue engine. The shaper queues are spaced generally equally in time. The enqueue engine determines whether a cell of data is one of conformant and non-conformant. A conformant cell is queued to a currently served queue and a non-conformant cell is shaped based on a cell delay time. A time spaced round robin (TSRR) scheduler connected to the plurality of per-class queues schedules cells of data from the shaper queues for transmission.

In another embodiment, the present invention is a data traffic manager that receives cell data of various class types from one or more data ports. The traffic manager includes a plurality of per-class queues connected to the one or more data ports, wherein at least one per-class queue is provided for each class of cell data and cell data from each class is queued in its respective queue. A first scheduler is connected to the plurality of per-class queues for scheduling the cell data and associated virtual connection (VC) traffic and Quality of Service (QoS) parameters. A shaper enqueue engine is connected to the first scheduler for managing the cells and their associated VC and QoS data. A plurality of per-class shaper queues are connected to the enqueue engine. The per-class shaper queues receive and queue respective cells and their associated data managed by the enqueue engine. At least one shaper queue is provided for each class. A second scheduler is connected to the plurality of per-class shaper queues for scheduling cells of data from the shaper queues for transmission. A timer is connected to the second scheduler and provides timing information thereto

In yet another embodiment, the present invention provides a method of managing ATM data traffic, comprising the steps of:

receiving ATM cell data from a data port;

analyzing the received data with an enqueue engine using a modified generic cell rate algorithm (GCRA);

placing the analyzed cell data into one of a plurality of per-class shaper queues; and

scheduling the cell data stored in the per-class shaper queues for transmission using a weighted/priority round robin algorithm.

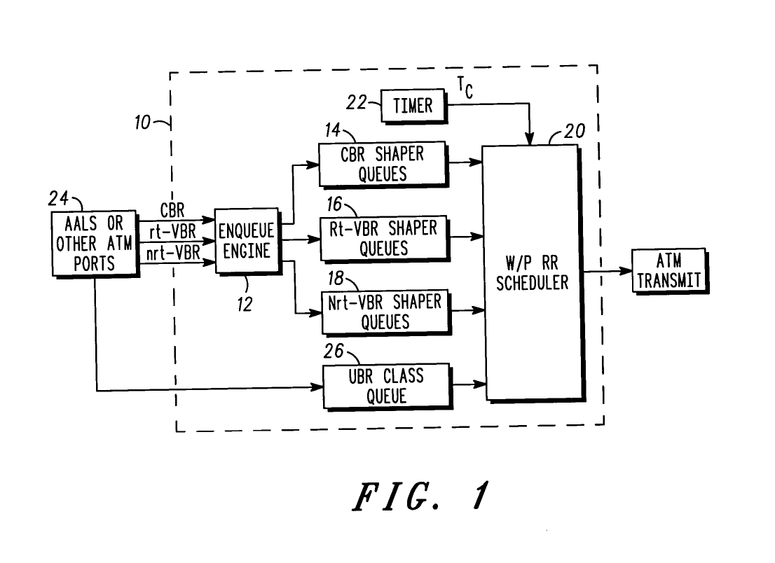

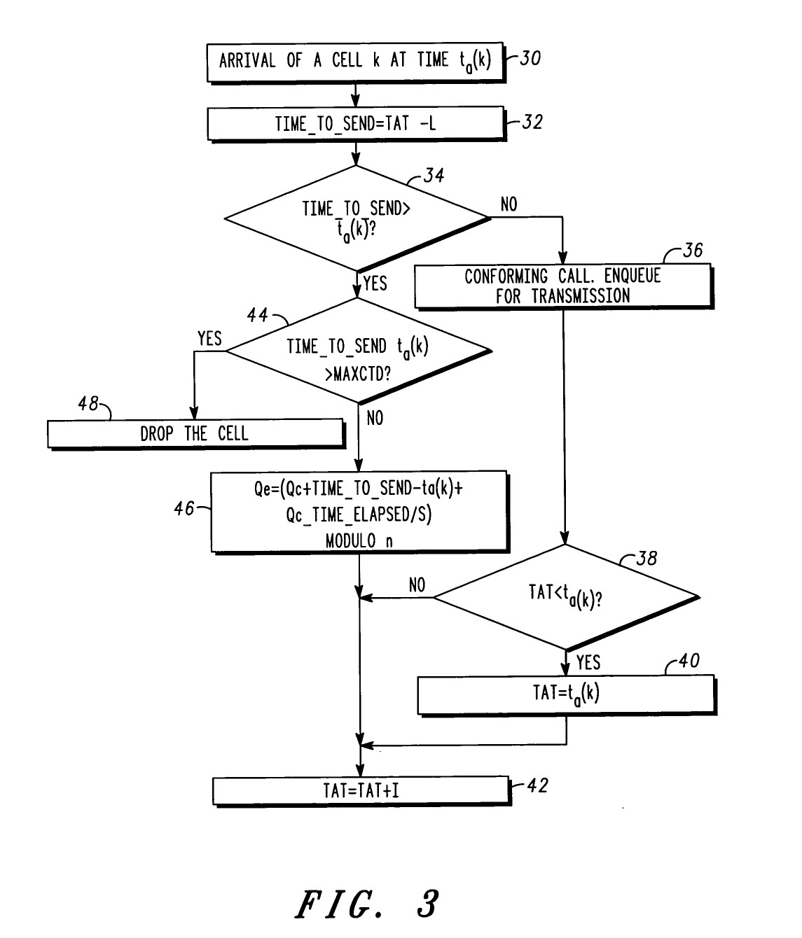

Referring now to FIG. 1, a functional block diagram of a data traffic manager 10 in accordance with an embodiment of the present invention is shown. The data traffic manager 10 includes an enqueue engine 12, a plurality of per-class shaper queues 14, 16 and 18, a scheduler 20 and a timer 22. The enqueue engine 12 is connected to at least one port 24 for receiving cells of data. In the embodiment shown, the port comprises ATM Adaptation Layers (AAL) or other ATM ports. The enqueue engine 12 receives constant bit rate (CBR), real time-variable bit rate (rt-VBR) and non-real time variable bit rate (nrt-VBR) cells of data via the port 24. As understood by those of skill in the art, the difference between rt-VBR and nrt-VBR is the QoS parameters that they specify. rt-VBR specifies the same QoS parameters as CBR, i.e., cell loss ratio, peak-to-peak cell delay variation and maximum cell transfer delay, while nrt-VBR specifies only CLR as a QoS parameter. The enqueue engine 12 may also receive unspecified bit rate (UBR) cells of data. The enqueue engine 12 determines whether a cell of data is either conformant or non-conformant using a GCRA or preferably, a modified GCRA, such as the modified GCRA shown in FIG. 3. A conformant data cell is queued to a currently served queue or the queue that is going to be served next if the current queue is full so that the conformant cell gets transmitted right away. For a non-conformant cell, the enqueue engine 12 determines whether the non-conformant cell has to be dropped or shaped based on how long the non-conformant cell has to be delayed to make it conformant and hence ready for transmission.

The plurality of per-class shaper queues 14, 16 and 18 are connected to the enqueue engine 12 and receive respective cells of data from the enqueue engine 12. The plurality of per-class shaper queues includes at least one CBR class queue 14, at least one rt-VBR class queue 16 and at least one non-real time variable bit rate nrt-VBR class queue 18. Preferably, each class queue 14, 16 and 18 includes a plurality of such queues. For example, the CBR class queue 14 could comprise thirty-two (32) queues such that each CBR class queue can hold about thirty-two cells of data. The rt-VBR and nrt-VBR shaper queues 16 and 18 may include a similar number of similarly sized queues. The data traffic manager 10 preferably also includes a UBR class queue 26 for UBR data.

The scheduler 20 is connected to the plurality of per-class shaper queues 14, 16 and 18 and the UBR class queue 26 for scheduling cells of data from the shaper queues 14, 16, 18 and 26 for transmission. The scheduler 20 is preferably a time spaced round robin (TSRR) scheduler and in this embodiment, performs scheduling based on predetermined weight and/or priority values for each class, as well as timing information generated by the timer 22.

More particularly, for each class (CBR, rt-VBR and nrt-VBR), there are ‘n’ shaper queues of size ‘s’ (queue length—number of cells that a queue can hold), where n and s may be different for each class depending on granularity and a total number of queues available. The shaper queues 14, 16, 18 and 26 are spaced generally equally in time with ‘Ts’ as a quantum of time where Ts=s*Tc (cell time). The timer 22, which is connected to the scheduler 20, generates ticks for the cell time Tc. For example, for OC-3c, 1 cell time Tc is about 2.8 μs. Put another way, each shaper queue within a class is serviced cyclically for s ticks in a cycle of n*s ticks.

The shaper queues 14, 16, 18 and 26 are serviced cyclically for ‘Ts’ duration and for each cell transmission only one queue from each class is scanned. For each tick Tc (cell time), W/P RR (Weighted/Priority Round-Robin) scheduler 20 scans currently served queues (one from each class) based on class weight/priority. In case of priority round robin, all the cells in the CBR queue 14 are scheduled before the rt-VBR queue 16 and all cells in the rt-VBR queue 16 are scheduled before the nrt-VBR queue 18. Cells from the UBR class queue 26 are scheduled only when there are no cells to be scheduled from the other class queues 14, 16, and 18. In the case of weighted round robin, the CBR queue 14 is serviced Wcbr times, the rt-VBR queue 16 is serviced Wrt-VBR times, the nrt-VBR queue 18 is serviced Wnrt-VBR times and the UBR queue 26 is serviced Wu times, where W is a weight value.

Shaping is basically delaying the transmission of a cell by placing the cell in the appropriate shaper queue. While the scheduler 20 schedules cells from the shaper queues 14, 16, 18 and 26 for transmission, the enqueue engine 12 manages the shaper queues 14, 16 and 18 (but not the UBR queue 26). The time the cell has to be delayed is the difference between the current time and the time at which the cell should be transmitted. If this difference exceeds a predetermined value (referred to as maxCTD in FIG. 3), in one embodiment of the invention, the cell is immediately dropped. The shaper queue to be used for delaying the cell is determined based on the time difference and the queue that is currently being served. The cell is queued to the respective shaper queue based on queue thresholds. The cell is dropped or discarded if the shaper queue is above the non-conformant threshold of the class.

Referring now to FIG. 3, a flow chart of a modified GCRA used by the enqueue engine 12 is shown. As mentioned above, in this embodiment the enqueue engine 12 manages the shaper queues 14, 16 and 18 with a threshold tail drop mechanism and protects queue availability for conformant cells. Step 30 indicates the arrival of a cell k at a time tₐ(k). At step 32, the time at which the cell is to be sent or transmitted (Time_to_send) is determined as TAT-L, where TAT is a theoretical arrival time and L is a limit value. TAT can have an initial value of current time. For CBR, L is equal to CDVT (Cell Delay Variation Tolerance) and for rt-VBR and nrt-VBR, L is equal to BT (burst tolerance)+CDVT, where, BT=(MBS−1)*(1/SCR−1/PCR). MBS is maximum burst size; SCR is sustainable cell rate; and PCR is peak cell rate. At step 34, the calculated time to send is compared to the cell arrival time tₐ(k). If the time to send is not greater than the arrival time, then the cell is a conforming cell and the algorithm proceeds to step 36, where it is queued in the currently served queue for transmission. Step 38 follows step 36. At step 38, TAT is compared to tₐ(k). If TAT is less than tₐ(k), then at step 40, TAT is set to the value of tₐ(k) and at step 42 TAT is incremented by I (the increment value I equals 1/PCR for CBR, and 1/SCR for rt-VBR and nrt-VBR). On the other hand, if TAT is not less than tₐ(k), then TAT is incremented by I at step 42. At step 34, if the time to send is greater than tₐ(k), then the algorithm proceeds to step 44 to determine the time that the cell has to be delayed. At step 44, the time to send less the arrival time tₐ(k) is compared to a predetermined maximum value (maxCTD) and if the difference is greater than maxCTD, then the cell is dropped at step 48. If the difference is not greater than maxCTD, then the algorithm proceeds to step 46. At step 46, the shaper queue to which the cell is queued (Qₑ) is determined as Qₑ=(Q_{c}+Time_to_send−tₐ(k)+Q_{c—}time_elapsed/s) modulo n. After the shaper queue Qₑ is determined, TAT is incremented by I, at step 42 and then the next received data cell is processed.

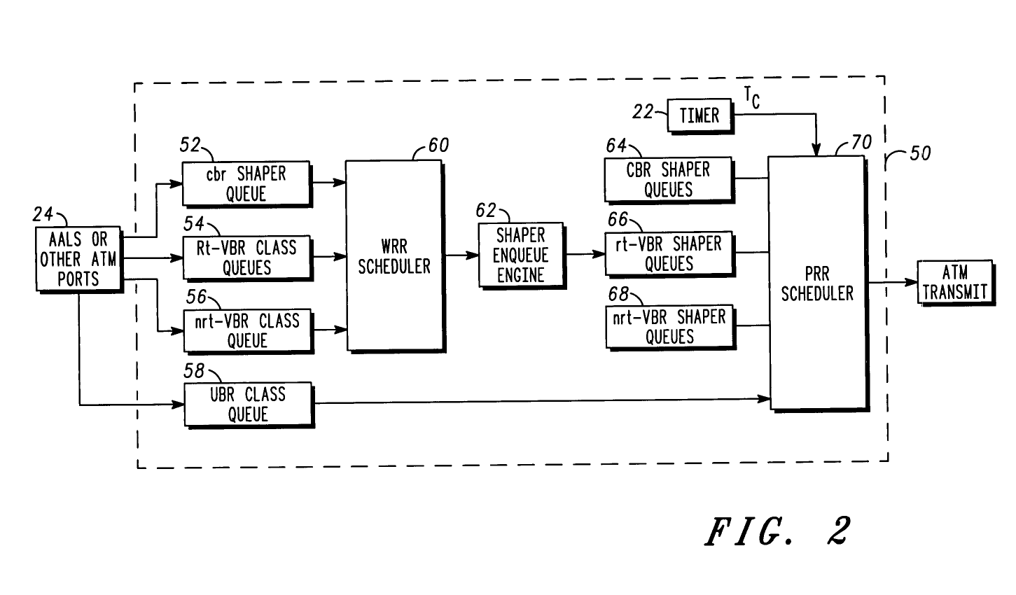

Several implementations of the data traffic manager in accordance with the present invention are possible. However, the concepts and fundamental blocks like modified GCRA, enqueue engine, round-robin schedulers remain the same. Referring now to FIG. 2, another embodiment of a data manager 50 in accordance with the present invention is shown. The data manager 50 may be implemented using a RISC processor, such as a Motorola C-Port Network processor. The data manager 50 has two levels of scheduling, one at ingress, before shaping, and another at egress, before transmission. At ingress, Weighted Round Robin (WRR) scheduling is used and at egress strict priority scheduling is used.

Like the data manager 10 in FIG. 1, the data manager 50 is connected to an AALs (ATM Adaptation Layers—upper layers of ATM) or other ATM ports to receive ATM cells. The received data cells are placed into respective class queues. Accordingly, the data manager includes a CBR class queue 52, an rt-VBR class queue 54, a nrt-VBR class queue 56 and an UBR class queue 58. A WRR scheduler 60 receives the data cells from the class queues 52, 54 and 56 based on weights assigned to each of the classes. In one embodiment, the CBR, rt-VBR and nrt-VBR class queues 52, 54 and 56 are assigned weights of 4, 3 and 1 respectively so that the CBR class queue 52 is serviced four out of eight times, the rt-VBR class queue 54 is serviced three out of eight times and the nrt-VBR class queue 56 is serviced one out of eight times.

The WRR scheduler 60 is connected to a shaper enqueue engine 62. The shaper enqueue engine 62 receives the cells dequeued by the WRR scheduler 60 and shapes them by placing the cells in various queues. It should be understood that the shaper enqueue engine 62 receives not just cells of data, but also their associated VC and QoS data. Like the enqueue engine 12, the enqueue engine 62 is connected to a plurality of CBR shaper queues 64, a plurality of rt-VBR shaper queues 66 and a plurality of nrt-VBR shaper queues 68. Also like the enqueue engine 12, the enqueue engine 62 maintains and manages the different sets of shaper queues for each class (except UBR class) with a simple tail drop mechanism and protects queue availability for conformant cells using thresholds. The enqueue engine 62 determines the shaper queue to be used for the cell with a modified GCRA (FIG. 3) as described above. The shaper queues 64, 66 and 68 and the UBR class queue 58 are connected to a PRR scheduler 70 that schedules cells from the shaper queues 64, 66 and 68 and the UBR class queue 58 based on the class priority. Shaper queues within a class are serviced cyclically based on a timer tick Tc generated by the timer 22 and time spacing between queues (Ts=s*Tc) and across classes, a strict priority scheduling is used. That is, all cells in currently serviced CBR queue 64 are scheduled before rt-VBR queue 66 and all cells in currently served rt-VBR queue 66 are scheduled before nrt-VBR queue 68. Cells belonging to the UBR class and stored in the UBR class queue 58 are not shaped and are scheduled only when there are no cells in the other class queues.

In addition to the data traffic managers 10 and 50 discussed above, the present invention also provides a method of managing ATM cell data received at a data port. In the method, the received data is analyzed with an enqueue engine, like the enqueue engines 12 and 62 using a modified generic cell rate algorithm (GCRA) as shown in FIG. 3. The analyzed data is placed into one of a plurality of per-class shaper queues 14, 16 and 18 and the cell data stored in the per-class shaper queues is scheduled for transmission using a weighted/priority round robin algorithm, such as the one implemented by the scheduler 20. For an ATM traffic manager, the plurality of per-class shaper queues includes at least one CBR class queue, at least one rt-VBR class queue and at least one non-real time variable bit rate nrt-VBR class queue. Preferably however, for each class there are ‘n’ shaper queues of size ‘s’, where n and s are different for each class depending on granularity and a total number of queues available. Each shaper queue 14, 16, 18 and 26 within a class is serviced cyclically for ‘s’ ticks in a cycle of n*s ticks.

A traffic manager in accordance with the present invention needs just one timer and scans only one queue per-class during each cell time period, which makes the traffic manager computationally efficient, simple and scalable. As compared to prior art data traffic shapers, the present invention uses relatively simple to implement algorithms like the modified GCRA to determine the shaper queue for en-queuing cells and weighted or priority round robin scheduling for de-queuing cells from the shaper queues. Different sets of shaper queues for CBR, rt-VBR and nrt-VBR traffic classes are used and the scheduler dequeues cells from these sets of queues in weighted/prioritized fashion, which provides class isolation and prioritization. Further, Cell Delay Variation is controlled with ‘n’, shaper queues, ‘s’ (queue length—number of cells that a queue can hold) and ‘Ts’ (time space between queues) for each class. It should also be noted that according to the present invention, the shaping decision is based on GCRA and cells arriving in burst are placed in appropriate shaping queues, as opposed to using an overflow queue.

The description of the preferred embodiments of the present invention have been presented for purposes of illustration and description, but are not intended to be exhaustive or to limit the invention to the forms disclosed. It will be appreciated by those skilled in the art that changes could be made to the embodiments described above without departing from the broad inventive concept thereof. For example, a data traffic manager can be used to manage other types of data besides ATM, such as variable size IP data. It is understood, therefore, that this invention is not limited to the particular embodiments disclosed, but covers modifications within the spirit and scope of the present invention as defined by the appended claims.

1. A data traffic manager, comprising:
an enqueue engine connected to at least one port for receiving cells of data, wherein the enqueue engine determines whether a cell of data is one of conformant and non-conformant;
a plurality of per-class shaper queues connected to the enqueue engine that receive respective cells of data from the enqueue engine, wherein the shaper queues are spaced generally equally in time and wherein a conformant cell is queued to a currently served queue and a non-conformant cell is shaped based on a cell delay time; and
a time spaced round robin (TSRR) scheduler connected to the plurality of per-class queues for scheduling cells of data from the shaper queues for transmission.

2. The data traffic manager of claim 1, wherein the enqueue engine is connected to at least one ATM port.

3. The data traffic manager of claim 2, wherein the enqueue engine receives constant bit rate (CBR) cells, real time-variable bit rate (rt-VBR) cells and non-real time variable bit rate (nrt-VBR) cells.

4. The data traffic manager of claim 3, wherein the plurality of per-class shaper queues includes at least one CBR class queue, at least one rt-VBR class queue and at least one non-real time variable bit rate nrt-VBR class queue.

5. The data traffic manager of claim 4, wherein for each class, there are ‘n’ shaper queues of size ‘s’, wherein n and s are different for each class depending on a granularity and a total number of queues available.

6. The data traffic manager of claim 5, wherein each shaper queue within a class is serviced cyclically for ‘s’ ticks in a cycle of n*s ticks.

7. The data traffic manager of claim 6, wherein between classes, the TSRR scheduler performs scheduling based on predetermined weight and priority values for each class.

8. The data traffic manager of claim 4, wherein the plurality of per-class shaper queues includes a UBR class queue.

9. The data traffic manager of claim 8, further comprising a timer connected to the TSRR scheduler for providing timing information thereto.

10. The data traffic manager of claim 9, wherein the TSRR scheduler schedules cells from the shaper queues and the UBR class queue based on predetermined weight and priority values and timing information generated by the timer.

11. The data traffic manager of claim 9, wherein the enqueue engine manages the shaper queues with a threshold tail drop mechanism and protects queue availability for conformant cells.

12. The data traffic manager of claim 11, wherein the enqueue engine discards a cell that has to be delayed beyond a predetermined time period.

13. The data traffic manager of claim 9, wherein the enqueue engine discards a cell when the shaper queue thereof exceeds a predetermined threshold value.

14. The data traffic manager of claim 9, wherein the enqueue engine determines a shaper queue to be used for a data cell via a generic cell rate algorithm (GCRA).

15. The data traffic manager of claim 9, wherein the enqueue engine determines a shaper queue to be used for a data cell via a modified generic cell rate algorithm (GCRA).

16. A data traffic manager that receives cell data of various class types from one or more data ports, the traffic manager comprising:
a plurality of per-class queues connected to the one or more data ports, wherein at least one per-class queue is provided for each class of cell data and cell data from each class is queued in its respective queue;
a first scheduler connected to the plurality of per-class queues for scheduling the cell data and associated virtual connection (VC) traffic and Quality of Service (QoS) parameters;
a shaper enqueue engine connected to the first scheduler for managing the cells and their associated VC and QoS data;
a plurality of per-class shaper queues connected to the enqueue engine that receive and queue respective cells and their associated data managed by the enqueue engine, wherein at least one shaper queue is provided for each class;
a timer for generating timing information; and
a second scheduler, connected to the plurality of per-class shaper queues and the timer, for scheduling cells of data from the shaper queues for transmission.

17. The data traffic manager of claim 16, wherein the first scheduler schedules the cell data and associated VC and QoS parameters from the per-class queues using a weighted round robin algorithm.

18. The data traffic manager of claim 17, wherein the shaper enqueue engine determines which shaper queue is to be used for queuing cell data using a modified generic cell rate algorithm (GCRA).

19. The data traffic manager of claim 18, wherein the shaper enqueue engine manages the shaper queues with a threshold tail drop mechanism.

20. The data traffic manager of claim 19, wherein the shaper enqueue engine discards cell data that has to be delayed beyond a predetermined time limit.

21. The data traffic manager of claim 18, wherein the second scheduler schedules the cell data from the per-class shaper queues based on a class weight and priority algorithm.

22. The data traffic manager of claim 21, wherein the shaper enqueue engine manages the shaper queues within a class cyclically using the timing information generated by the timer.

23. The data traffic manager of claim 22, wherein the shaper enqueue engine manages the shaper queues such that between classes, scheduling is performed on a class priority basis.

24. The data traffic manager of claim 16, wherein the plurality of per-class queues includes constant bit rate (CBR), real time variable bit rate (rt-VBR), non-real time variable bit rate (nrt-VBR), and unspecified bit rate (UBR) class queues.

25. The data traffic manager of claim 24, wherein the plurality of per-class shaper queues includes CBR, rt-VBR, and nrt-VBR class queues.

26. A method of managing ATM data traffic, comprising the steps of:
receiving ATM cell data from a data port;
analyzing the received data with an enqueue engine using a modified generic cell rate algorithm (GCRA);
placing the analyzed cell data into one of a plurality of per-class shaper queues; and
scheduling the cell data stored in the per-class shaper queues for transmission using a weighted priority round robin algorithm.

27. The method of managing ATM data traffic of claim 25, wherein plurality of per-class shaper queues includes at least one CBR class queue, at least one rt-VBR class queue and at least one non-real time variable bit rate nrt-VBR class queue.

28. The method of managing ATM data traffic of claim 26, wherein for each class, there are ‘n’ shaper queues of size ‘s’, wherein n and s are different for each class depending on a granularity and a total number of queues available.

29. The method of managing ATM data traffic of claim 27, wherein each shaper queue within a class is serviced cyclically for ‘s’ ticks in a cycle of n*s ticks.

30. The method of managing ATM data traffic of claim 28, wherein the plurality of per-class shaper queues includes a UBR class queue.
